(19) United States
(12) Patent Application Publication
(10) Pub. No.: US 2012/0025587 A1
(43) Pub. Date: Feb. 2, 2012

(54) Process for forming a connecting structure between the column and seating portion of an office chair, and a structure obtained by said process

(75) Inventor: Andrea Francesco Zanchetta, Bassano del Grappa (VI) (IT)

(73) Assignee: IMARC S.P.A., Rossano Veneto (VI) (IT)

(21) Appl. No.: 13/257,299

(22) PCT Filed: Apr. 14, 2010
(86) PCT No.: PCT/EP2010/054851

§ 371 Date: Oct. 3, 2011

(30) Foreign Application Priority Data
Apr. 23, 2009 (IT) VE2009A000023

(51) Int. Cl. A47C 31/00; B29C 45/14

(52) U.S. Cl. 297/463.1; 264/265

(57) ABSTRACT

A method for forming connecting structures between the column and seating portion for office chairs, characterised by:-forming a frusto-conical portion (8) provided with a flange (24, 26, 28) by cold-pressing a portion of sheet metal,-inserting said flanged portion into a mould (32) reproducing the shape of the structure,-injecting plastic material into the mould in such a manner as to incorporate the flanged portion (24, 26, 28) of said frusto-conical portion (8) into the plastic material.

The present invention relates to a system for forming a connecting structure between the column and seating portion in office chairs, and a structure obtained by the method.

Office chairs are known, generally consisting of a support base provided with wheels and a rotatable column of variable height, the upper end of which is inserted into a box support internally housing the adjustment mechanisms for the seating portion and back rest.

These structures are subjected to intensive use and consequently have to be able to resist the tests required by international regulations of this sector.

One of the points most subjected to structural stresses is the connection between the structure and the rotatable column, which generally consists of a traditional gas spring enabling the seating portion to be height adjusted. Generally the connection between the column and the structure is obtained by a male conical part provided in the head of the column and insertion-fitted into a corresponding female conical part obtained in the structure.

A first known type of box support is obtained by die-casting aluminium. However, this structure has the drawback of a high cost due to the materials used, to the die-casting operations, and to the metal structure finishing operations and the grinding of tolerance holes.

Moreover, all the holes in which pins rotate require the use of costly self-lubricating sockets to prevent seizure and jamming of movements.

Chair structures have also been obtained by pressing sheet metal parts followed by welding the steel sockets.

This solution has however the drawback of high cost due to welding and painting operations.

Moreover, with this solution, self-lubricating sockets again have to be used, and the pieces obtained are considerably limited in terms of shape.

Products have also been proposed with an integral plastic structure or with steel cones fitted together or over-moulded, but the structural characteristics are insufficient for intensive product use. Moreover the cost of this possible conical component, usually obtained by lathe turning or from a tube, is high.

The object of the invention is to eliminate these drawbacks by providing a structure for office chairs which is simple, comfortable and highly reliable.

This object is attained according to the invention by a method for forming connecting structures between the column and seating portion of office chairs as described in claim 1.

The present invention is further clarified hereinafter with reference to the accompanying drawings, in which:

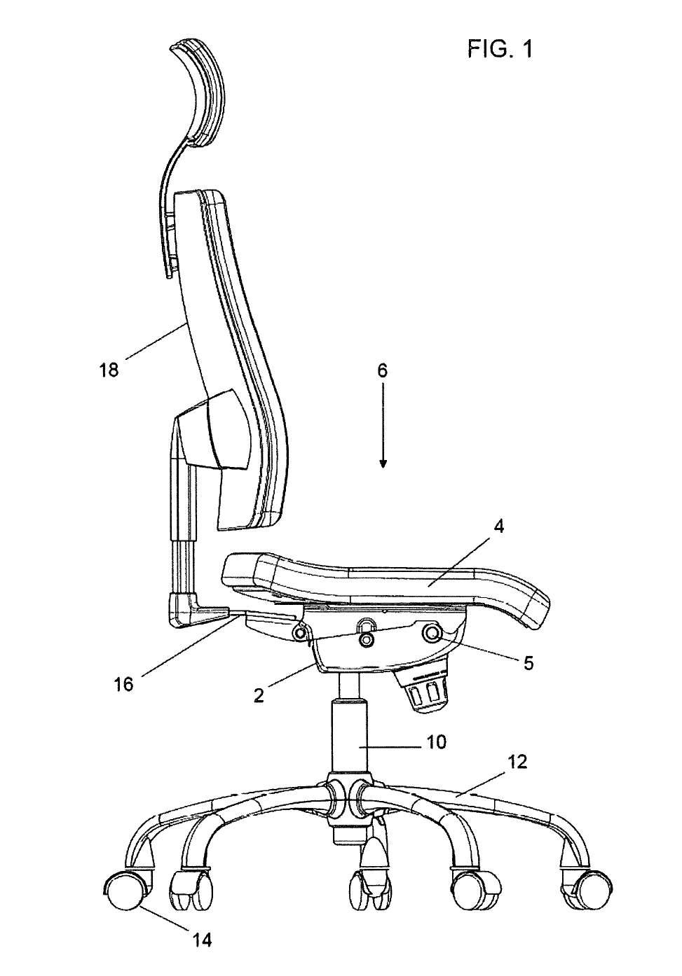

FIG. 1 is a perspective view of a chair provided with the structure of the invention,

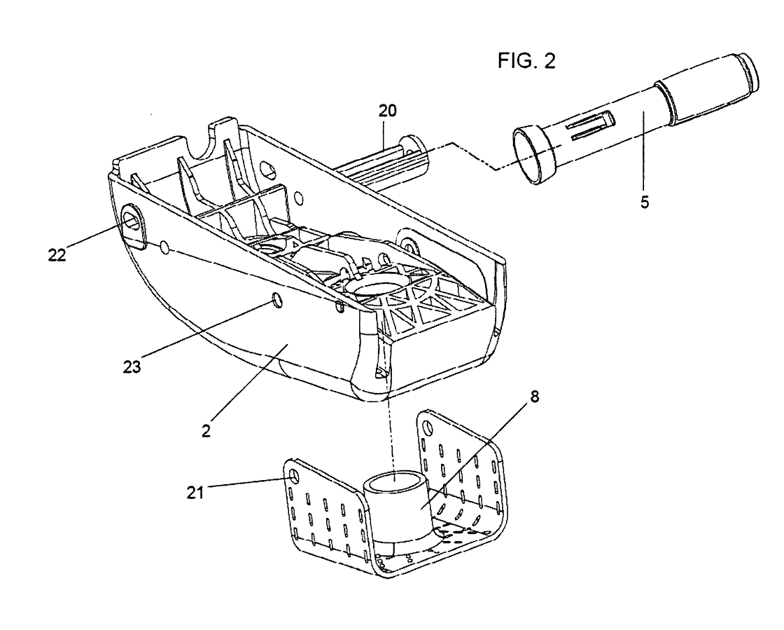

FIG. 2 is an exploded perspective view of the lower part of the box support,

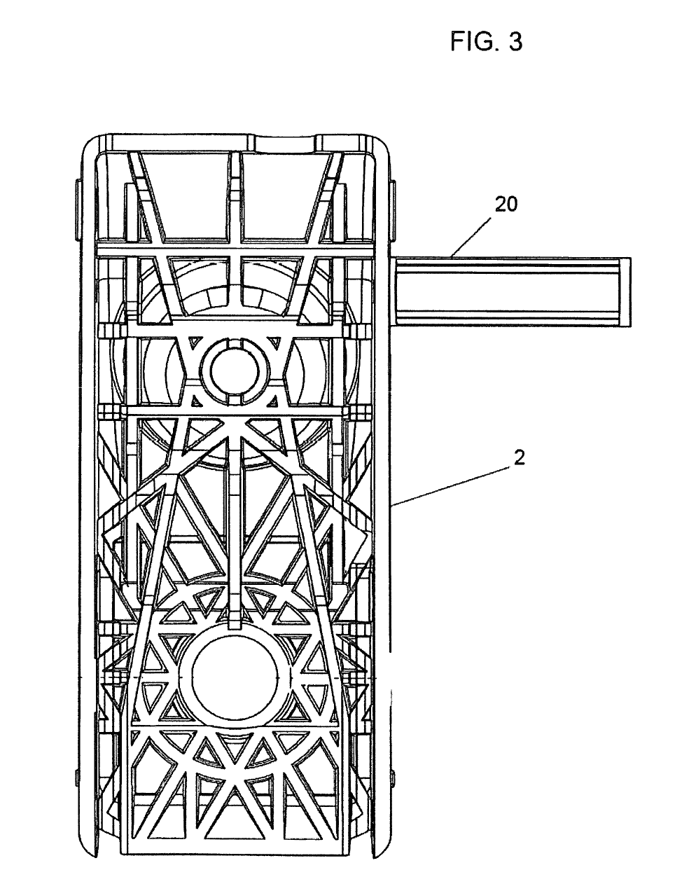

FIG. 3 is a plan view thereof,

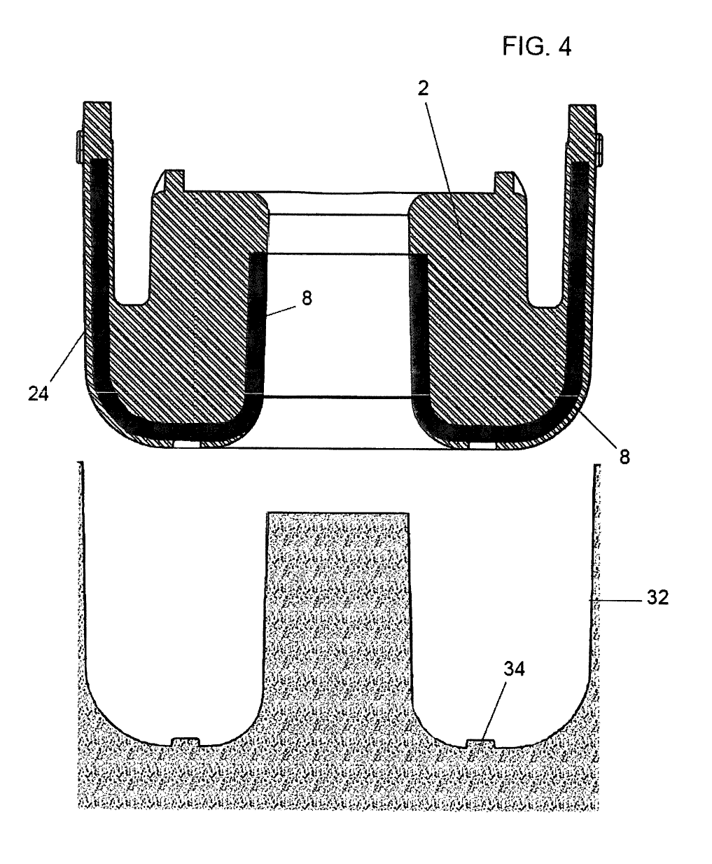

FIG. 4 is a schematic longitudinal section showing the step of extracting the structure from the mould, and

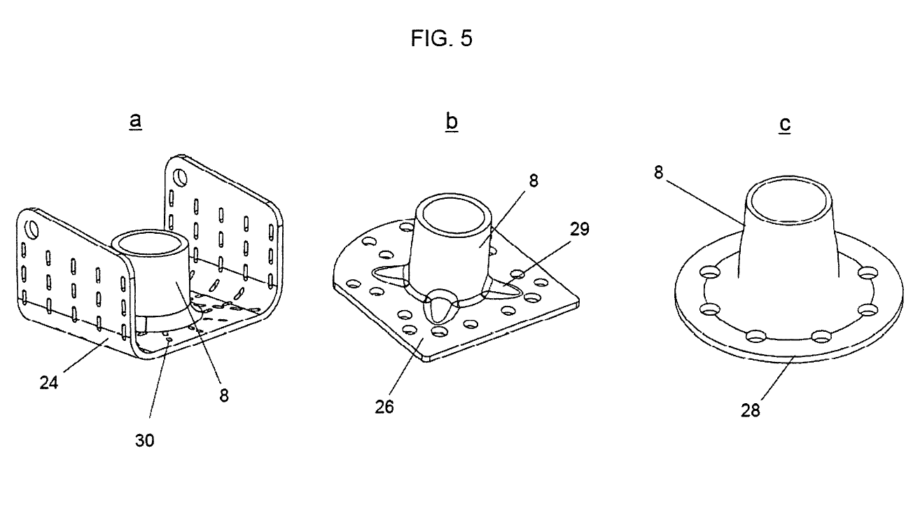

FIGS. 5a, 5b and 5c show three different embodiments of the metal insertion joint.

As can be seen from the figures, the structure of the invention, indicated overall by 2, is applied to the lower part of the seating portion 4 of an office chair 6 and is provided with a frusto-conical socket 8 for insertion-fitting the upper end of a traditional gas spring 10, the function of which is to support the structure 2 on a support base 12 with wheels 14, and at the same time to regulate the height of the seat.

The arm 16 for supporting the back rest 18 of the chair 6 is also hinged to the structure 2. A lever 5 for adjusting the mechanism is also connected to the structure 2.

The box support is formed by injection moulding plastic material, preferably polyamide filled with glass fibre, the frusto-conical socket 8 being formed by pressing sheet metal.

The structure is provided internally with a plurality of reinforcement ribs which connect the frusto-conical part of the metal portion to the side walls in order to stiffen the structure. To reduce the overall size during transport, the structure is provided with an element 20 for quick-coupling the control lever 5, which can be easily mounted at the destination. In the plastic side walls, seats 22 and 23 are provided for housing passage pins for the adjustment members. The metal pins can be mounted in this manner without the risk of seizure problems arising or without the need to mount additional sockets.

The socket 8 for mounting on the head of the column 10 can be provided with a U-shaped flange 24, see FIGS. 2 and 5a, or a flat flange of traditionally square shape 26 (FIG. 5b) or of circular shape 28 (FIG. 5c), perfectly symmetrical to simplify orientation in the case of automatically loading the piece to be over-moulded into the mould. The pressed sheet metal piece can also comprise reinforcement bosses 29 to stiffen the connection between the conical portion and the base flange (FIG. 5b).

Of whatever shape this flange is formed, it comprises a plurality of holes 30 for enabling a more effective grip during injection moulding. If the passage holes for the plastic correspond with the reinforcement ribs, the structural bond is further reinforced. In the case of seats for those pins which are particularly stressed, the metal structure is made to continue to the interior of the side walls, and passages 21 for these pins are provided such as to transfer the load directly to the metal, hence stressing the plastic structures to a lesser extent.

To form the structure, the flanged socket is placed in a mould 32, then the plastic is injected thereon to form the box support at the end of the injection process. The base of the mould is provided with positioning pegs 34 which maintain the flanged socket raised from the mould base.

From the aforegoing it is apparent that the structure of the invention presents numerous advantages, and in particular:

it can be formed easily and comfortably by an injection moulding operation,
it avoids the use of additional components such as bushes, screws and pins,
it has the necessary strength to pass the regulation tests,
there are less design constraints on the shape to be used,
it can be easily industrialized,
it is of low cost as all work subsequent to its formation is eliminated.

The invention claimed is:

1. A method for forming connecting structures between the column and seating portion for office chairs, characterised by:
forming a frusto-conical portion (8) provided with a flange (24, 26, 28) by cold-pressing a portion of sheet metal,
inserting said flanged portion into a mould (32) reproducing the shape of the structure,
injecting plastic material into the mould in such a manner as to incorporate the flanged portion (24, 26, 28) of said frusto-conical portion (8) into the plastic material.

2. A method as claimed in claim 1, characterised in that said flange (24, 26, 28) is formed in a position corresponding with the frusto-conical base of the sheet metal portion.

3. A method as claimed in claim 1, characterised by providing a plurality of holes (30) in the flanged portion.

4. A method as claimed in claim 1, characterised in that said flanged portion is formed of U-shape.

5. A method as claimed in claim 4, characterised in that the side walls of the U-shaped portion present seats (21) for the passage of pins.

6. A method as claimed in claim 2, characterised by forming said flanged portion with reinforcement bosses (29) which connect it to the frusto-conical portion (8).

7. A method as claimed in claim 1, characterised by forming reinforcement ribs (19) in the plastic structure.

8. A connecting structure between the column and the seating portion in an office chair obtained by the method claimed in claim 1, characterised by a tray-shaped body (2) formed of plastic material over-moulded onto a flanged frusto-conical portion (8) forming the seat for insertion-fitting the support column (10) for the seating portion (4).

9. A structure as claimed in claim 8, characterised in that the flange of the frusto-conical portion comprises holes (30).

10. A structure as claimed in claim 8, characterised by comprising reinforcement ribs (19) which connect the metal frusto-conical part to the side walls of said plastic support structure.

11. A structure as claimed in claim 10, characterised in that said reinforcement ribs (19) are provided in positions corresponding with the flange holes (30).

12. A structure as claimed in claim 8, characterised in that said support structure is provided with a quick coupling (20) for the control levers.

13. A structure as claimed in claim 8, characterised by being provided with sockets (22, 23) for housing pins integrated into the structure itself
